(19) United States
(12) Patent Application Publication
(10) Pub. No.: US 2011/0112961 A1
(43) Pub. Date: May 12, 2011

(54) Duplicate Payments Suspect Review Workstation

(76) Inventors: Frank Stokes, Boone, NC (US); Steve Fortson, Little River, SC (US); Charles Brinza, Granite City, IL (US); Richard Gierak, Clayton, CA (US); Noreen Sila, Underhill, VT (US); Ronald Larry Ratzlaff, Colorado Springs, CO (US)

(21) Appl. No.: 12/608,790

(22) Filed: Oct. 29, 2009

Related U.S. Application Data
(60) Provisional application No. 61/197,800, filed on Oct. 30, 2008.
(60) Provisional application No. 61/197,794, filed on Oct. 30, 2008.
(60) Provisional application No. 61/197,756, filed on Oct. 30, 2008.

(51) Int. Cl. G06Q 40/00

(52) U.S. Cl. 705/39

(57) ABSTRACT

A work station may be used to eliminate duplicate payment transactions.

### CROSS-REFERENCE TO RELATED APPLICATIONS

This application claims the benefit of U.S. Provisional Application Nos. 61/197,800, 61/197,794 and 61/197,756 filed on Oct. 30, 2008, which applications are hereby incorporated by reference for all purposes in their entirety.

### STATEMENT REGARDING FEDERALLY SPONSORED RESEARCH OR DEVELOPMENT

N/A

### REFERENCE TO MICROFICHE APPENDIX

N/A

### BACKGROUND OF THE INVENTION

1. Field of the Invention

The present invention relates to payment transactions and more particularly to banking programs.

2. Description of the Related Art

With the advent of the Check 21 legislation, payments originating as checks are now entering financial institutions' payment streams in various forms, including automated clearinghouse (ACH) payments, electronic cash letters, X9.37 electronic files from customers and other capture centers, paper checks and Image Replacement Documents. For example, a paper check may be scanned at a retail check-out counter and converted to an ACH transaction. Another example occurs when banks exchange electronic cash letters consisting of the checks' electronic images instead of exchanging the actual checks. Still another example occurs when paper checks are captured in a remote processing center and then converted into X9.37 format and transmitted to a consolidating location instead of sending paper checks.

Conversion of paper checks to various electronic media has created opportunities for banks to save on processing costs, float, and transportation. However, this flexibility of payment presentment has created an environment where the same payment can be presented multiple times and posted to the individual customer account multiple times. This “double posting” of payments, although unintentional, causes customer relationship problems and results in added expense to the hank. Correcting these errors costs the bank both time and money, as well as risking customer satisfaction and the bank's reputation.

Some banks have simply chosen to detect the duplicate payment one or more days after the event occurred and correct the mistake by reversing the payment posting, preferably before the customer realizes the event happened. But this can often result in the customer's account being overdrawn.

### BRIEF SUMMARY OF THE INVENTION

A computer implemented method and system are provided for comparing payment transactions and identifying duplicate transactions. A workstation may be used for reviewing the duplicate payment suspects to distinguish the true duplicate payments from the false positive duplicate payments. In one embodiment, prior payment transactions that have been received may be loaded into a duplicate detection data base. Succeeding payment transactions that are received may also be loaded into the duplicate detection data base and a high-performance data comparison technology may be used to compare the later payments in the data base as they arrive with the payments previously loaded into the data base for the purpose of detecting duplicate payment transactions. Any match in the comparison may be designated as a duplicate payment suspect and may be reviewed to determine if the suspect is a valid duplicate payment or a false positive duplicate payment. Duplicates may be forwarded to a posting system to prevent payment and to prevent the duplicate payment from posting to the customer's account.

Human intervention may be used to distinguish false positive duplicate payments from true duplicate payments. A workstation may be used to retrieve images of the duplicate suspects and a determination made if the duplicate suspects are true duplicates. After verification, the operator may then disposition the payment as a duplicate payment that is forwarded to the posting system to prevent posting to customer accounts or cleared as a false positive suspect and allowed to proceed to posting against customer accounts. In an alternative embodiment, the distinguishing of false positive duplicate payments from true duplicate payments may be done automatically.

Exceptions, including returned items, stop payments, and insufficient funds, may be given special consideration to prevent them from being identified as duplicate payments. The duplicate payment prevention system distinguishes these items from true duplicate payments.

### BRIEF DESCRIPTION OF THE DRAWINGS

For a better understanding of the nature and object of the present invention, reference should be had to the following drawings in which like parts are given like reference numerals and wherein:

FIG. 1 is a schematic block diagram of the duplicate prevention process including the work station.

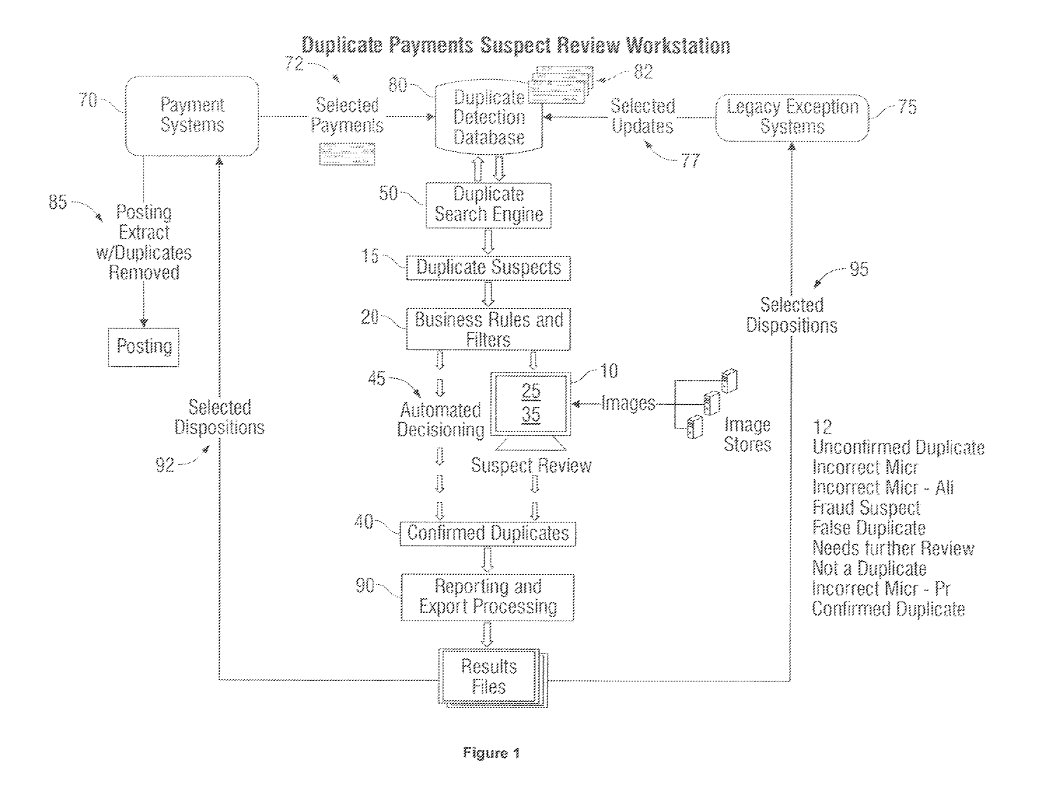

### DETAILED DESCRIPTION OF THE INVENTION

The system and method prevents duplicate postings on Day 1, the day a payment arrives at the bank for processing. By comparing each payment, regardless of source of entry into the bank, with every other payment received by the hank during a prior period of time, such as the last 30+ days, a file containing all the duplicate suspects can be created. From this list of suspects, the true duplicates may be separated from the false positive suspects. False positive suspects are payments that appear to be duplicates but are actually good payments. Some examples of a false positive suspect would be multiple rebate checks offered by a single manufacturer all having the same MICR information, or a monthly mortgage payment with the same MICR information as the payment from the previous month. In addition, computer-generated checks from software such as Quicken are a source of false positive duplicates since the MICR information can be adjusted by the user and the check appears to be the same payment made in the previous month. A Process for Resolving Duplicate Payment Postings in Day 1 is proposed in U.S. Provisional Application No. 61/197,794 filed on Oct. 30, 2008 and incorporated herein by reference for all purposes in its entirety.

Not all matches detected by the system may be duplicate payments. There are exceptions that may be identified as duplicate suspects, but may not actually be duplicates. These suspect duplicates may be called false positive suspects. False positive suspects can result from any payment loaded onto the data base containing the identical MICR information as a payment that currently resides on the data base. An example of such a payment would be a mortgage payment with the exact RT, account, and amount that is paid by a customer each month. Check printing, software can also create checks with duplicate MICR information and yet be a legitimate paper check. Rebate checks sent out to thousands of customers may all appear to be the same and therefore may be flagged by the system as a duplicate payment.

Returned items that have been denied payment from correspondent banks may make up a significant portion of items that may be identified as false positive duplicates because returns may enter the duplicate data base more than once. A payment may be presented by a hank to a correspondent bank for payment multiple times. Each time the payment is presented, it may appear as a duplicate payment.

The present invention includes a Duplicate Payments Suspect Review Workstation 10. The Workstation 10 allows the bank personnel (not shown) to resolve any duplicates in real time prior to posting. The workstation 10 loads the duplicate suspects 15 into memory and presents an image of the suspected duplicate payment 25 along with an image of the previous payments 35 that it identified as a match while searching the data base for duplicate payments. Bank personnel (not shown) can examine the two images and determine if the new payment is a true duplicate 40 or simply a false positive suspect. The operator (not shown) can then choose the best method of disposing of the duplicate by making a selection from multiple hank defined disposition codes 12. Once the duplicate is properly handled, an image of the next duplicate suspect 25 and images of all matching payments 35 is presented to the operator (not shown) and the process is repeated. The workstation 10 enables quick and simple dispositioning of all duplicates in real time, before posting.

The duplicate detection data base 80 is used by the duplicate search engine 50 to compile the duplicate suspects 15. A Duplicate Payment Prevention system and method are proposed in U.S. Provisional Application No. 61/197,756 filed on Oct. 30, 2008 and incorporated herein by reference for all purposes in its entirety. Selected payments 72 are ingested into the data base 80 from the payment system 70. Selected updates 77 originating from the bank's legacy exception systems 75 can also be ingested into the data base 80. For example, updates from the bank's Returns system can be ingested into the data base 80 to identify any returned items so that those items will not be falsely identified as duplicates upon re-presentment. Updates from the bank's Adjustment system can be ingested so that existing items in the data base 80 will reflect any changes to MICR and other data made during the Adjustment process.

The present invention includes a reporting capability 90 such that all items processed through the payment system interface are updated 92 with a disposition code assigned either automatically via the business rules or manually by an operator. Downstream payment processes balancing, posting, and transit processing) use this information to resolve the exception conditions identified in the appropriate manner. (For example, removal of the confirmed duplicates from posting extracts 85 or cash letter processing.)

The present invention also includes an export capability 90 that supports reporting of selected items to any external bank system based on the assigned disposition codes. For example, any changes in duplicate status 95 resulting from the processing of updates 77 from the banks legacy exception systems 75 can be reported hack to the system from which the updates were presented. Another example is the reporting of items dispositioned as “fraud suspects” to the bank's fraud systems for resolution.

It should be understood that although the method and system are described with regard to banks, the method and system are equally applicable to other businesses having payment transactions.

The foregoing disclosure and description of the invention are illustrative and explanatory thereof, and various changes in the details of the illustrated apparatus and system, and the construction and method of operation may be made without departing from the spirit of the invention.

We claim:

1. A computer work station system comprising:
a first computer;
a display screen;
a keyboard; and
a first computer software program loaded onto said first computer for identifying duplicate payment transactions having substantially identical payment amounts.

2. The system of claim 1, further comprising:
a second computer software program loaded onto said first computer having a criteria for distinguishing payment transactions having substantially identical payment amounts.

3. The system of claim 2, wherein said first computer software program and said second computer software program being one software program.

4. The system of claim 1, further comprising:
a second computer; and
a second computer software program loaded onto said second computer having a criteria for distinguishing payment transactions having substantially identical payment amounts.

5. The system of claim 1, further comprising:
a data base loaded onto said second computer having payment transactions.

6. A computer implemented method comprising the steps of:
providing a first computer software program for identifying duplicate payment transactions having substantially identical payment amounts;
submitting first payment transactions to said first computer software program at a first time;
providing a data base to said first computer software program comprising second payment transactions for a time period ending at or before said first time;
comparing said first payment transactions with said second payment transactions;
identifying if said first payment transactions are contained in said data base;
submitting each of said first payment transactions and said second payment transactions with substantially identical payment amounts to a second computer software program having a criteria for distinguishing payment transactions having substantially identical payment amounts;
applying said criteria to each of said first payment transactions and said second payment transactions having substantially identical payment amounts; and
determining whether each of said first payment transaction and said second payment transactions having substantially identical payment amounts are duplicates.

7. The method of claim 6, further comprising the step of:
reporting whether each of said first payment transaction and said second payment transactions having substantially identical payment amounts are duplicates on a workstation monitor display.

8. The method of claim 6, further comprising the step of:
reporting within twenty-four hours of said first time whether each of said first payment transactions and said second payment transactions having substantially identical payment amounts are duplicates.

9. The method of claim 6, further comprising the step of:
posting each of said first payment transactions that are not a duplicate.

10. The method of claim 9, wherein said posting of said first payment transaction occurring within twenty-four hours of said first time.

11. The method of claim 6, wherein said data base is a duplicate data base.

12. The method of claim 6, wherein said first computer software program and said second computer software program being one program.

13. The method of claim 6, wherein said data base updated continuously.

14. A computer implemented method comprising the steps of:
providing a first computer software program for identifying duplicate payment transactions having substantially identical payment amounts;
submitting first payment transactions to said first computer software program at a first time;
providing a data base to said first computer software program comprising second payment transactions for a time period ending at or before said first time;
comparing said first payment transactions with said second payment transactions;
identifying if said first payment transactions are contained in said data base; and
reporting whether each of said first payment transaction and said second payment transactions having substantially identical payment amounts are duplicates on a workstation monitor display.

15. The method of claim 14, further comprising the step of:
reporting within twenty-four hours of said first time whether each of said first payment transactions and said second payment transactions having substantially identical payment amounts are duplicates.

16. The method of claim 14, further comprising the step of:
posting each of said first payment transactions that are not a duplicate.

17. The method of claim 16, wherein said posting of said first payment transaction occurring within twenty-four hours of said first time.

18. The method of claim 14, wherein said data base is a duplicate data base.

19. The method of claim 14, wherein said data base updated continuously.
